(19) United States
(12) Patent Application Publication
(10) Pub. No.: US 2014/0162563 A1
(43) Pub. Date: Jun. 12, 2014

(54) Connectivity Verification and Notification

(71) Applicant: John J. Mastrototaro, Los Angeles, CA (US)

(72) Inventor: John J. Mastrototaro, Los Angeles, CA (US)

(73) Assignee: Medtronic MiniMed, Inc., Northridge, CA (US)

(21) Appl. No.: 13/712,664

(22) Filed: Dec. 12, 2012

(51) Int. Cl. H04B 17/00

(52) U.S. Cl. CPC H04B 17/00
USPC 455/67.7

(57) ABSTRACT

A system to monitor communications integrity is disclosed. The system includes a portable medical device with a medical device transmitter to establish a medical device link. The medical device link defined to periodically transmit data from the portable medical device to a remote system with a receiver to receive the medical device link. The remote system further including a remote system transmitter defined to establish a mobile device link. The mobile device link defined to periodically report status of the medical device link to the mobile system, the mobile system further having a plurality of alarm triggers associated with the integrity of the medical device link and the mobile device link.

### FIELD OF THE INVENTION

This invention relates to allowing secondary parties to monitor connectivity of medical devices, the invention further relates to notification of secondary parties if there is a connectivity failure between the medical device and a cloud based service or the secondary party and the cloud based service.

### BACKGROUND OF THE INVENTION

Over the years, bodily characteristics have been determined by obtaining a sample of bodily fluid. For example, diabetics often test for blood glucose levels. Traditional blood glucose determinations have utilized a painful finger prick using a lancet to withdraw a small blood sample. This results in discomfort from the lancet as it contacts nerves in the subcutaneous tissue. The pain of lancing and the cumulative discomfort from multiple needle pricks is a strong reason why patients fail to comply with a medical testing regimen used to determine a change in characteristic over a period of time. Although non-invasive systems have been proposed, or are in development, none to date have been commercialized that are effective and provide accurate results. In addition, all of these systems are designed to provide data at discrete points and do not provide continuous data to show the variations in the characteristic between testing times.

A variety of implantable electrochemical sensors have been developed for detecting and/or quantifying specific agents or compositions in a patient's blood or interstitial fluid. For instance, glucose sensors have been developed for use in obtaining an indication of blood glucose levels in a diabetic patient. Such readings are useful in monitoring and/or adjusting a treatment regimen which typically includes the regular administration of insulin to the patient. Thus, glucose readings improve medical therapies with semi-automated medication infusion pumps of the external type, as generally described in U.S. Pat. Nos. 4,562,751; 4,678,408; and 4,685,903; or automated implantable medication infusion pumps, as generally described in U.S. Pat. No. 4,573,994, which are herein incorporated by reference. Typical thin film sensors are described in commonly assigned U.S. Pat. Nos. 5,390,671; 5,391,250; 5,482,473; and 5,586,553 which are incorporated by reference herein, also see U.S. Pat. No. 5,299,571. However, the monitors for these continuous sensors provide alarms, updates, trend information and require sophisticated hardware to allow the user to program the monitor, calibrate the sensor, enter data and view data in the monitor and to provide real-time feedback to the user. This sophisticated hardware makes it most practical for users that require continuous monitoring with feedback to maintain tight control over their conditions. In addition, these systems require the user to be trained in their use, even if to be worn for short periods of time to collect medical data which will be analyzed later by a doctor.

Doctors often need continuous measurements of a body parameter over a period of time to make an accurate diagnosis of a condition. For instance, Holter monitor systems are used to measure the EKG of a patient's heart over a period of time to detect abnormalities in the heart beat of the patient. Abnormalities detected in this manner may detect heart disease that would otherwise go undetected. These tests, while very useful are limited to monitoring of bio-mechanical physical changes in the body, such as a heart beat, respiration rate, blood pressure or the like.

Uploading results of continuous measurement of a body parameter to a central database has also been undertaken. However, reliability of mobile data networks can introduce difficulties in regularly obtaining data Likewise, it would be beneficial if a third party could monitor the integrity of a mobile data network connecting a patient to a central database.

### SUMMARY OF THE DISCLOSURE

A system to monitor communications integrity is disclosed. The system includes a portable medical device having a medical device transmitter. The medical device transmitter is used to establish a medical device link that includes sending periodic data from the portable medical device. Further included in the system is a remote system with a remote system receiver to receive the medical device link. The remote system further including a remote system transmitter defined to establish a mobile device link. Further included is a mobile system having a mobile system receiver to receive the mobile device link from the remote system. The mobile device link periodically reports status of the medical device link to the mobile system. The mobile system further includes a plurality of alarm triggers associated with the integrity of the medical device link and the mobile device link.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 is an exemplary illustration of components of a portable medical system that includes a controller and an infusion pump, in accordance with embodiments of the present invention.

FIG. 2 is an exemplary block diagram showing elements within the infusion pump in accordance with embodiments of the present invention.

FIGS. 3A-3D are exemplary diagrams illustrating various communication modes and communication failures between the portable medical system, a remote system, and a mobile device in accordance with embodiments of the present invention.

FIG. 4 is a flow chart illustrating a procedure that automatically disables non-delivery alarms when a relative distance between a controller and an infusion pump is exceeded, in accordance with one embodiment of the present invention.

FIGS. 5A and 5B are flow charts illustrating exemplary operations to verify the mobile device link, in accordance with embodiments of the present invention.

### DETAILED DESCRIPTION

Mobile data networks are enabling a wide array of data gathering that can be conducted in near real-time. In the mobile medical space, mobile data networks are enabling connected care where patients can upload physiological data in near real time without having to make a special trip to visit their physician or download data to a computer before sending it to a physician. Connected care also enables caregivers and family members the ability to more closely monitor physiological data gathered by sensors attached to mobile and remote patients. However, the reliability of mobile data networks and the patchwork of different data standards can result in spotty coverage and/or poor network performance.

Without operating an independent wireless data company it may be impossible to ensure a patient is within excellent mobile data network coverage. However, it is possible to determine the integrity of data connections between a portable medical system and a remote system. Furthermore, it is also possible to determine the integrity of a mobile data connection between a third party mobile device and the previously mentioned remote system.

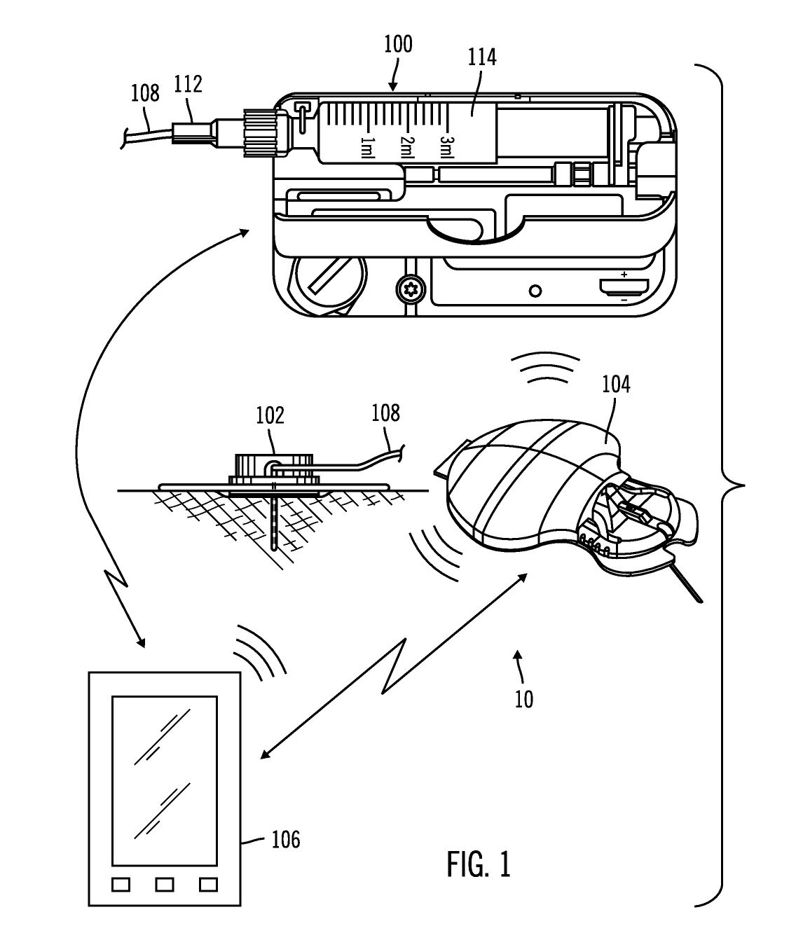

FIG. 1 is an exemplary illustration of components of a portable medical system 10 that includes a controller 106 and an infusion pump 100, in accordance with embodiments of the present invention. As the portable medical system 10 includes the infusion pump 100 the term “infusion system” can be used interchangeably with “portable medical system”. However, it should be understood that the present invention can be implemented with portable medical systems that do not include an infusion pump. It should further be understood that various embodiments of the portable medical system can include a variety of infusion pumps along with various controllers, such as but not limited external infusion pumps with integrated controllers, external and implantable infusion pumps with remote controllers and/or multi-function remote controllers. In one embodiment the infusion pump 100 has minimal controls incorporated on the infusion pump 100 and the controller 106 is the primary user interface device to interact with the infusion pump 100. In one embodiment the controller 106 exchanges data with the infusion pump 100 via bi-directional wireless communications facilitated by radios and/or optical interconnections such as infra-red or the like. In other embodiments, data transmission between the infusion pump 106 and the controller 100 can be performed via a wired connection.

In embodiments where the infusion pump 100 and the controller 106 communicate wirelessly, the controller 106 can be used to configure or program an associated infusion pump 100 to deliver a basal rate. Additionally, in some other embodiments the controller 106 can be used to program the infusion pump 100 to periodically remind a user via an alarm to deliver a bolus. Once the infusion pump 100 is programmed using the controller 106, the infusion pump 100 can execute the program without further interaction from the controller 106.

For example, using the controller 106 an infusion pump 100 is programmed to deliver a basal rate. Once programmed, the infusion pump 106 will deliver the basal rate without further input from the controller 100 until either a fluid reservoir 114 within the infusion pump 100 is exhausted via the basal rate, the power supply to the infusion pump 100 is exhausted, or another type of delivery failure. Thus, after the infusion pump 100 is programmed, the infusion pump 100 will execute the program independent of the controller 106. The controller 106 can be used to modify or augment the program of an infusion pump 100, however, the infusion pump 100 does not require continual or periodic updates from the controller 102 to execute a stored program.

Further included in the portable medical system 10 is an infusion set 102 that is coupled to the infusion pump 100 via tubing 108. The basal and bolus volumes delivered by the infusion pump 100 discussed above are delivered to a patient via the infusion set 102. In one embodiment the infusion set 102 includes a cannula 110 that is coupled to the tubing 108. In some of these embodiments the cannula 110 is positioned in the subcutaneous layer of the patient and a portion of the infusion set 102 remains outside of the patient's body. To prevent the cannula from falling out or moving some embodiments of the infusion set 102 include an adhesive layer to temporarily affix the infusion set 110 the skin of a patient.

The portable medical system 10 further includes a sensor assembly 104 that may be optional. In some embodiments the sensor assembly 104 is configured to wirelessly communicate with the controller 106 and/or the infusion pump 100. In particular embodiments the sensor assembly 104 includes a transmitter 112 that is coupled to a sensor 114. The sensor 114 can be defined to measure any number of physiological conditions and in one embodiment, the sensor 114 is defined to sense glucose concentration in interstitial fluid within the human body. In still other embodiments the sensor 114 is defined to sense glucose concentrations within the bloodstream. The transmitter 112 allows the signal generated by the sensor 114 to be transmitted to, in one embodiment the infusion pump 100, in another embodiment the controller 106, and in still another embodiment, both the infusion pump 100 and the controller 106.

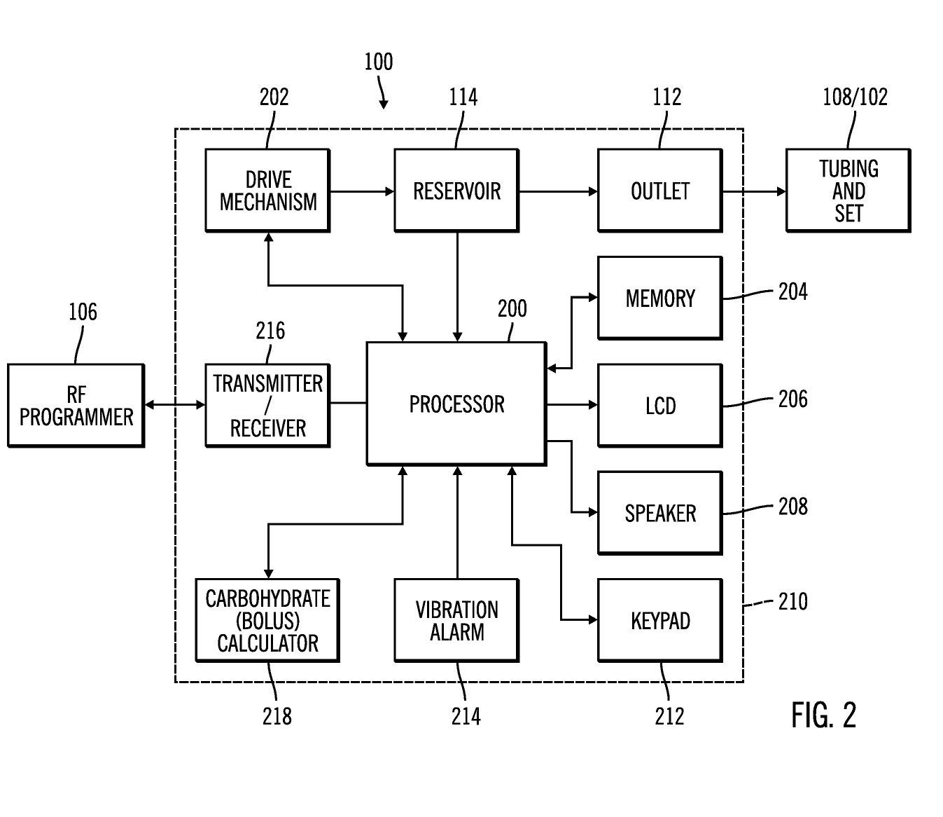

FIG. 2 is an exemplary block diagram showing elements within the infusion pump 100 in accordance with embodiments of the present invention. The infusion pump 100 includes a processor 200 that is coupled to a variety of elements such as a drive mechanism 202 that is further coupled to a reservoir 114. As shown in FIG. 2, the reservoir 114 is also coupled with the processor 200. Coupling both the drive mechanism 202 and the reservoir 114 to the processor 200 allows some redundancy when determining output from the reservoir 114 to the outlet 112 that is eventually passed through the tubing 108 and infusion set 102.

The processor 200 executes program instructions stored in a memory 204. While memory 204 is shown as coupled to the processor 200 in FIG. 2, other embodiments of the present invention have memory for storing program instructions integrated into memory on the processor 200 die. The processor 200 is further coupled to a display 206, shown as LCD in FIG. 2. Audible feedback and alarms are enable via a speaker 208 is coupled to the processor 200. A user is able to interact with the infusion pump 100 using a user interface 212, interchangeably referred to as a keypad. In other embodiments the user interface 212 is not limited to physical keypads and can include touchscreens, keyboards and the like. The user interface 212 can be used to program or configure a vibration alarm 214 and interact with a bolus calculator 218. Both the vibration alarms 214 and the bolus calculator are coupled to the processor.

A transmitter/receiver 216 is coupled to the processor to enable the controller 106, also referred to as an RF programmer, to control various aspects of the infusion pump 100, in accordance with embodiments of the present invention. The transmitter/receiver 216 further enables the infusion pump 100 to wirelessly communicate with the sensor assembly 104. Data received from the sensor assembly 104 can be stored in the memory 204 for real-time or near-real time processing by the processor 200.

In still other embodiments the transmitter/receiver 216 found in either both or each of the infusion pump 100 and the controller 106 allows either the infusion pump 100, the controller 106 or both the infusion pump 100 and the controller 106 to transmit data such as, but not limited to, ongoing therapy, the condition of various aspects of the pump and the condition of the user based on data from the sensor assembly 104.

For simplicity, the controller 106 is shown as a single block. However, in various embodiments of the present invention the controller 106 can include infusion pump 100 elements such as, but not limited to, the processor 200, the memory 204, the display 206, the speaker 208 and the interface 212 along with vibration alarm 214 and bolus calculator 218. In embodiments where the controller 106 includes various infusion pump 100 elements, the infusion pump 100 may lack duplicate and redundant components to reduce costs and make the infusion system more affordable. However, in other embodiments, redundant systems can be found in both the controller 106 and the infusion pump 100 to minimize likelihood suspension of therapy due to failure of one element.

While the particular embodiment of the portable medical system 10 discussed above is directed toward an infusion system the scope of the claimed subject matter should not be construed as limited to infusion systems. Other portable medical systems such as pacemakers, stand alone glucose sensors, and other portable sensors for the measurement of biological or physiological conditions should be considered within the scope of this disclosure. Other portable medical systems such as, but not limited to, pregnancy monitors and portable ultrasound diagnostic equipment could also considered within the scope of this disclosure.

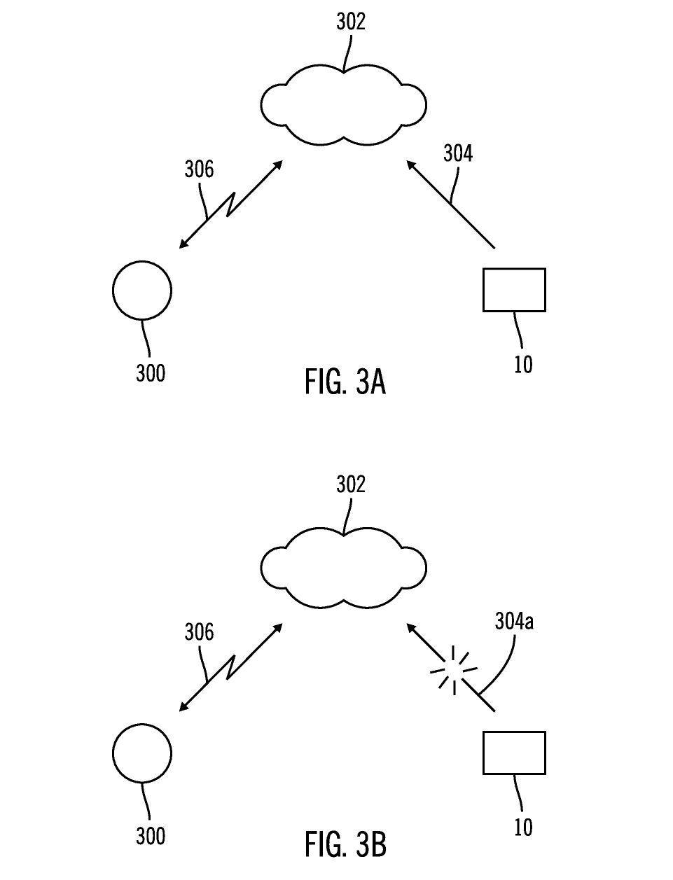

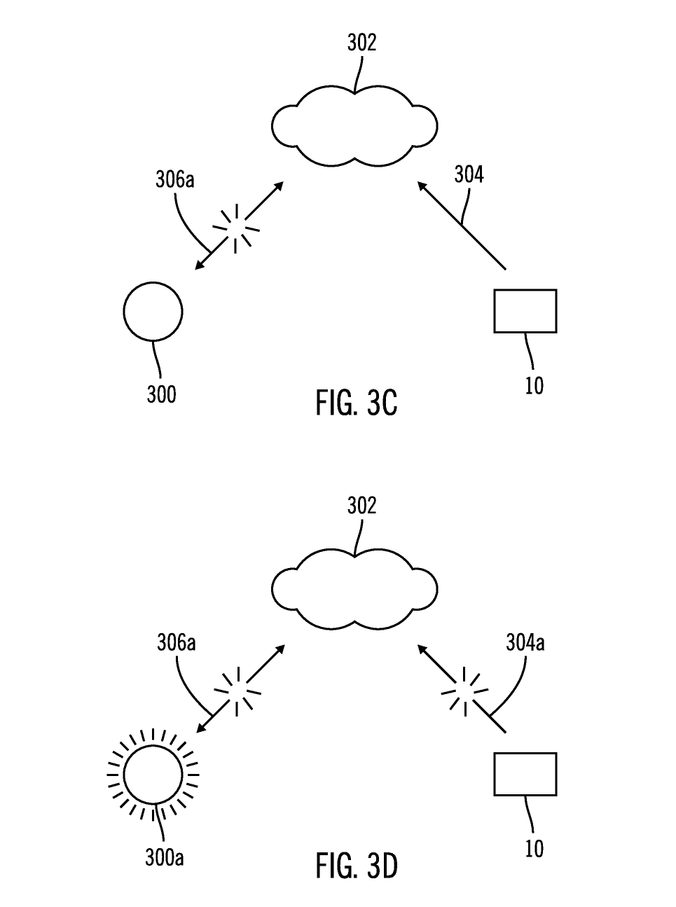

FIGS. 3A-3D are exemplary diagrams illustrating various communication modes and communication failures between the portable medical system 10, a remote system 302, and a mobile device 300 in accordance with embodiments of the present invention. FIG. 3A is an exemplary illustration of the portable medical system 10 with a medical device link 304 to a remote system 302. The remote system 302 further includes a mobile device link 306 to mobile device 300. The system illustrated in FIG. 3A allows a user of the mobile device 300 to verify that the mobile device link 306 and the medical device link 304 are intact. Likewise, the system shown in FIG. 3A can notify the user of the mobile device 300 that there is a failure in the communication links between either the mobile device link 306 or the medical device link 304.

In some embodiments the medical device link 304 and the mobile device link 306 are wireless data connections. Exemplary embodiments of the wireless data connection that can be used for the medical device link 304 and the mobile device link include, but are not limited to cellular protocols commonly referred to as GSM or CDMA along with cellular data protocols commonly referred to as 3G (EDGE, EDGE Evolution, CDMA2000, EV-DO, UMTS, HSPA), 4G (WiMAX, LTE), along with other commonly used wireless standards such as Wi-Fi. Various combination of the communication protocols listed above can be used to establish both the medical device link 304 and the mobile device link 306.

Accordingly, in many embodiments the mobile device 300 is a commercially available mobile device having a user interface such as, but not limited to a mobile telephone, tablet, netbook, notebook or ultrabook with an appropriate radio transmitter and receiver. In some embodiments the mobile device 300 is running an application that enables usage of the appropriate radios to enable the mobile device link 306. Additionally, the mobile device 300 is configured to run an application that enables configuration and customization of settings and alarms. In specific embodiments where the mobile device 300 includes tactile alarms such as vibration alarms along with audible and visual alarms the various alarms can be configured separately and with escalating levels.

With the portable medical system 10 described regarding FIGS. 1 and 2 as a base system, various embodiments include different levels of integration between the portable medical system 10 and the system used to create the medical device link 304. One embodiment integrates the wireless cellular radio into an element within the portable medical system 10. For example, a wireless cellular radio can be integrated into the infusion pump, the controller or even the sensor. However, integration of the wireless cellular radio within the portable medical system 10 can introduce numerous regulatory complexities. In still other embodiments, the portable medical system 10 can include a proprietary secure communication link between the portable medical system 10 and a commercially available wireless device such as, but not limited to a mobile telephone, tablet, netbook, notebook computer, or ultrabook with an appropriate radio transmitter. Regardless of the particular implementation of the wireless communication, the portable medical system 10 is defined to establish medical device link 304 with the remote system 302.

In one embodiment the remote system 302 is a secure remote data repository. For example embodiments the remote system 302 are an evolution of the CareLink therapy management software for diabetes from Medtronic. The remote system 302 is configured to receive data from a plurality of portable medical systems via the medical device link 304. In one embodiment, the portable medical system 10 is programmed to periodically ping the remote system 302 via the medical device link 304. In other embodiments, data collected by the portable medical system can be periodically uploaded to the remote system 302 via the medical device link 304. For examples, in embodiments where the portable medical system 10 includes a physiological sensor the sensor data can be uploaded periodically or even substantially in real-time. In one embodiment the portable medical system 10 includes a sensor configured to measure glucose concentrations and the medical device link allows the upload of either sensor data or calculated blood glucose values directly into the remote system 302.

The remote system 302 can be programmed to receive periodic communications from the portable medical system 10 via the medical device link 304. For example, the remote system 302 could be programmed to receive either a ping or physiological data from the portable medical system every five minutes. In embodiments where near real-time data from a physiological sensor is being collected and analyzed the frequency of the transmission between the portable medical system 10 and the remote system 302 can be more frequent such as but not limited to every five to thirty seconds. In still other embodiments where a simple ping is used to verify the integrity of the medical device link the data transmission may occur every fifteen minutes to every hour. In still other embodiments combinations of periodic physiological data and data pings can be used to verify integrity of the medical device link 304.

FIG. 3B is an exemplary illustration showing a broken medical device link 304a between the remote system 302 and the portable medical system, in accordance with embodiments of the present invention. As illustrated the broken medical device link 304a means the remote system 302 did not receive expected communications from the portable medical system 10. Accordingly, the remote system 302 has transmitted data to the mobile device 300 in order for the mobile device 300 to notify the user of the mobile device 300 that the medical device link has been compromised. In some embodiments the user of mobile device 300 is allowed to configure various alarm settings. For example, in one embodiment the alarm settings allow for an escalating alarm depending on how much time has elapsed since the remote system 302 received data from the portable medical device 10. In still other embodiments a combination of audible and tactile alarms are enabled on the mobile device. In still other embodiments combinations of audile, tactile and visual alarms are used to alert the user of the mobile device 300.

FIG. 3C is an exemplary illustration of a failed mobile device link 306a between the mobile device 300 and the remote system 302, in accordance with embodiments of the present invention. In one embodiment the remote system 302 is configured to periodically verify integrity of the mobile device link 306 between the remote system 302 and the mobile device 300. In such an embodiment the remote system 302 would be configured to periodically transmit data to the mobile device 300 via a functioning mobile device link 306 (see FIGS. 3A or 3B). In some embodiments the transmission from the remote system 302 to the mobile device would be a simple ping not even requiring an acknowledgement from the mobile device 300 to the remote system 302. With such an embodiment the mobile device could be running an application than expects a ping from the remote system at predefined synchronized time periods. So long as a ping from the remote system 302 arrives within a predefined window the mobile device recognizes that the mobile device link is intact and functioning. As shown in FIG. 3C the failed mobile device link 306a means the mobile device 300 will not be able to receive a periodic communication from the remote system 302. Accordingly, when the expected communication is not received by the mobile device program instructions on the mobile device alert the user of the mobile device that the mobile device link has indeed failed.

In still another embodiment, the mobile device 300 is configured to periodically verify integrity of the mobile device link between the remote system 302 and the mobile device 300. In this embodiment the mobile device 300 is configured to periodically initiate communications with the remote system 302 via the mobile device link. In order to verify the integrity of the mobile device link the remote system 302 would acknowledge receipt of the communications back to the mobile device 300. As shown in FIG. 3C the failed mobile device link 306a means the mobile device 300 was unable to receive an acknowledgement from the remote system 302. Thus, when the acknowledgement is not received back at the mobile device 300, the mobile device is programmed to notify the user that the mobile device link has been compromised.

FIG. 3D is an exemplary illustration showing failed medical device link 304a, failed mobile device link 306a and mobile device in alarm state 300a. This condition can be achieved when the remote system 302 fails to receive data from the portable medical system 10 and some aspect of the mobile device link 306 has failed. In each of the embodiments shown in FIGS. 3A-3D various customizable alarm schemes can be implemented to notify a user of the mobile device that the integrity of the communication systems has been compromised. For example, different alarm sounds and vibration patterns can be used to differentiate between failure of the medical device link and the mobile device link.

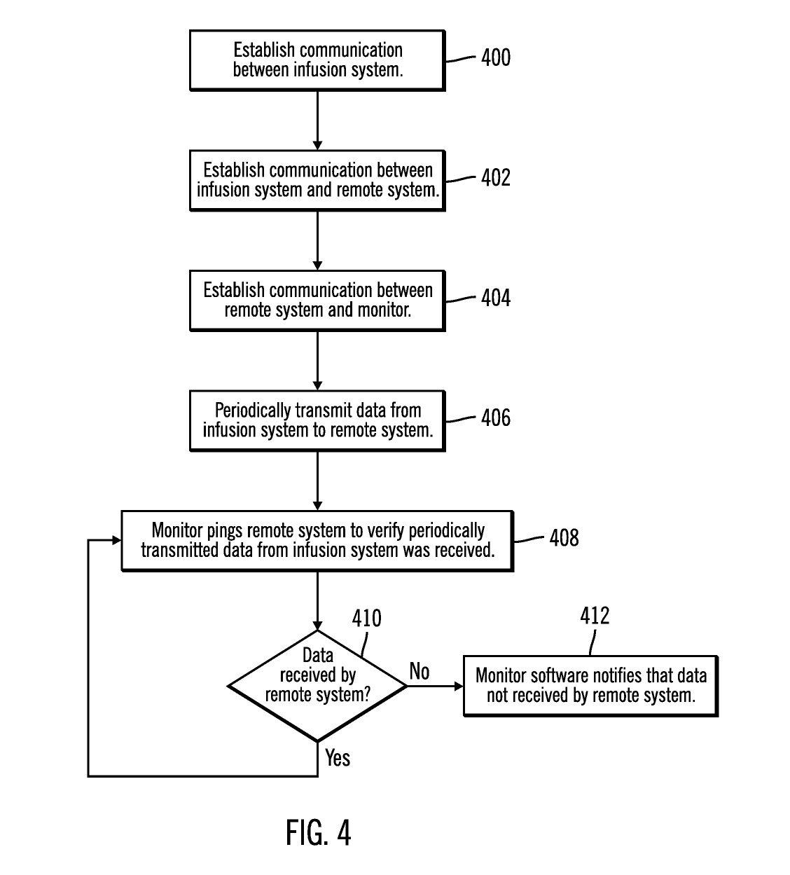

FIG. 4 is an exemplary flow chart illustrating operations to achieve connectivity verification and notification between the portable medical device, the remote system and a mobile device, in accordance with embodiments of the present invention. In embodiments where the portable medical system includes a plurality of elements interconnected via wireless communications protocols operation 400 establishes communication within the portable medical system. One embodiment that could require operation 400 is a portable medical infusion system as shown in FIG. 1, where the wireless sensor and wireless controller establish communication with the infusion pump. In other embodiments a first operation can be operation 402 that establishes communications between the portable medical system and the remote system. Operation 404 establishes communication between the remote system and the mobile device. As discussed above one embodiment of the remote system is a system similar to CareLink from Medtronic Diabetes. In still other embodiments the remote system includes encrypted communication between the portable medical system and the chosen remote system.

Operation 406 periodically transmits data from the portable medical system to the remote system. In some embodiments the periodic transmission from the portable medical system is analogous to a ping command where there is no acknowledgement from the remote system back to the portable medical device. In other embodiments the remote system is able to acknowledge receiving the periodic communication from the portable medical system. In still other embodiments where the portable medical system includes the ability to measure a physiological condition of a user, the periodic transmission may include patient data related to the measured physiological condition. For example, in embodiments where the portable medical system includes the ability to measure glucose concentration the periodic signal may include raw measured glucose concentration of calculated blood glucose values. Regardless of the particular embodiments of periodic transmission, operation 408 monitors transmissions from the portable medical system to verify the periodic transmissions are arriving according to a predefined schedule. Operation 410 verifies that the periodic transmission have been received by the remote system. If operation 410 determines a periodic transmission has been received from the portable medical device operation 408 is repeated. If operation 410 determines a periodic transmission has not be received by the remote system operation 412 sends a notification to the mobile device that the medical device link has been interrupted.

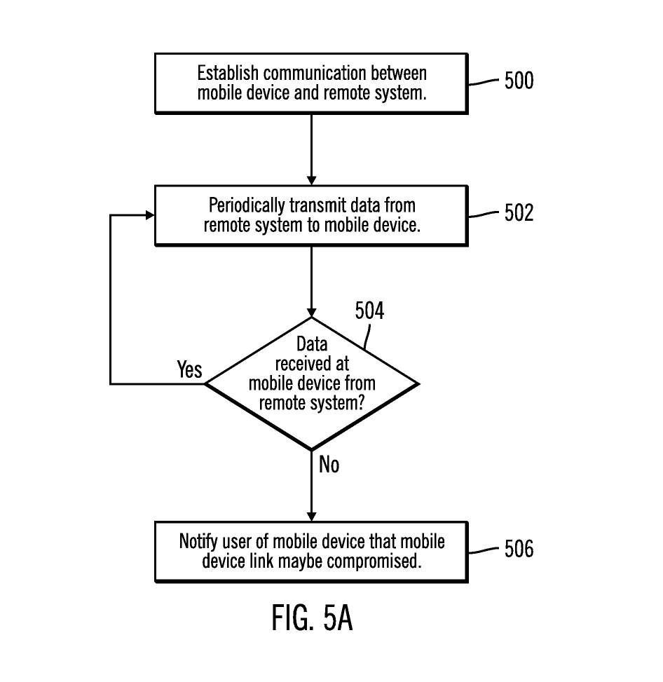

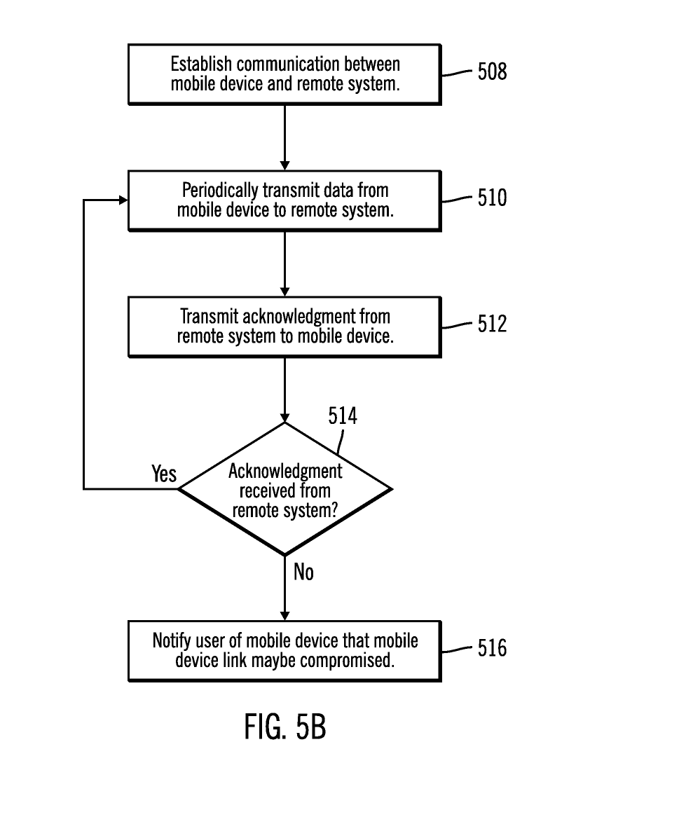

FIGS. 5A and 5B are flow charts illustrating exemplary operations to verify the mobile device link, in accordance with embodiments of the present invention. FIG. 5A begins with operation 500 that establishes communication between the mobile device and the remote system, also referred to as the mobile device link. As previously discussed, the mobile device link can be created by executing an application on a mobile device such as a smartphone or tablet. In other embodiments the mobile device can be a standalone piece of custom hardware. Operation 502 periodically transmits data from the remote system to the mobile device. With embodiments where the mobile device is an application being executed on a mobile device the mobile device can be programmed to expect a periodic transmission from the remote system. Operation 504 determines if data from the remote system was received at the mobile device. If data was received by the mobile device the flowchart returns to operation 502. If data was not received by the mobile device operation 506 notifies the user of the mobile device that the mobile device link maybe compromised. In some embodiments the mobile device includes various alarm triggers associated with the integrity of the medical device link and the mobile device link

FIG. 5B is another exemplary embodiment of operations that can verify the integrity of the mobile device link. Operation 508 establishes the mobile device link by creating a communication link between the mobile device and the remote system. Operation 510 periodically transmits data from the mobile device to the remote system and operation 512 sends an acknowledgement from the remote system to the mobile device. The acknowledgement confirms receipt of the data from the mobile device at the remote system. Operation 514 determines if the mobile device received the acknowledgement from the remote system. If the acknowledgement was received the mobile device link is intact and the flowchart returns to operation 510. If the acknowledgment is not received operation 516 notifies the user of the mobile device that the mobile device link maybe compromised.

While the description above refers to particular embodiments of the present invention, it will be understood that many modifications may be made without departing from the spirit thereof. The accompanying claims are intended to cover such modifications as would fall within the true scope and spirit of the present invention. The embodiments discussed regarding infusion systems and glucose sensors should not be construed as restrictive. Any portable medical system that updates a remote system periodically or in real-time can benefit from the communication connectivity system described above. For example, it would be possible to include the connectivity verification system with medical systems such as pregnancy monitors, pacemakers, standalone glucose sensors and other portable sensors that measure biological or physiological parameters.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system to monitor communications integrity comprising:
a portable medical device having a medical device transmitter to establish a medical device link, the medical device link transmitting periodic data from the portable medical device;
a remote system having a remote system receiver to receive the medical device link, the remote system further including a remote system transmitter defined to establish a mobile device link; and
a mobile system having a mobile system receiver to receive the mobile device link, the mobile device link defined to periodically report status of the medical device link to the mobile system, the mobile system further having a plurality of alarm triggers associated with the integrity of the medical device link and the mobile device link.

2. A system as defined in claim 1, wherein one of the plurality of alarm triggers is activated when the medical device link is compromised such that the mobile system receives data from the remote system that the remote system failed to receive periodic data from the portable medical device.

3. A system as defined in claim 1, wherein one of the plurality of alarm triggers is activated when the mobile system fails to receive periodic report status via the mobile link.

4. A system as defined in claim 1, wherein the mobile device link is bidirectional, the mobile system further includes a mobile transmitter defined to periodically ping the remote system, the mobile receiver further defined to receive a response from the remote system transmitter.

5. A system as defined in claim 3, wherein one of the plurality of alarm triggers is activated with failure of the mobile system to receive a response from the remote system to a ping.

6. A method to monitor communication integrity comprising:
establishing a first communication link between a portable medical device and a remote server;
establishing a second communication link between the remote server and a mobile device;
periodically verifying the first communication link;
periodically verifying the second communication link;
detecting a failure of either the first communication link or the second communication link; and
initiating an alarm on the mobile device if a failure of either the first communication link or the second communication link is detected.

7. The method to monitor communication integrity as described in claim 6, wherein the second communication link is bidirectional.

8. The method to monitor communication integrity as described in claim 7, wherein verification of the second communication link is initiated from the mobile device.

9. The method to monitor communication integrity as described in claim 7, wherein verification of the second communication link is initiated from the remote system.

10. The method to monitor communication integrity as described in claim 6, wherein the first communication link is from the portable medical device to the remote system.

11. The method to monitor communication integrity as described in claim 6, wherein receiving data from the portable medical device at specific time intervals verifies the first communication link.

12. The method to monitor communication integrity as described in claim 11, wherein the specified time intervals are configured by a user.

13. The method to monitor communication integrity as described in claim 11, wherein the specific time intervals are not equal.

14. The method to monitor communication integrity as described in claim 6, where failure of the first communication link has a first alarm and failure of the second communication link has a second alarm.

15. The method to monitor communication integrity as described in claim 14 wherein the first alarm and the second alarm are visual, audible, tactile or a combination thereof.

16. The method to monitor communication integrity as described in claim 14 wherein the alarm escalates in intensity until acknowledged by a user.
